(19) United States
(12) Patent Application Publication
(10) Pub. No.: US 2005/0121928 A1
(43) Pub. Date: Jun. 9, 2005

(54) Leaves and yard debris removal tool

(76) Inventor: Leonard L. Hierath, Denver, CO (US)

Correspondence Address: MERCHANT & GOULD PC, P.O. BOX 2903, MINNEAPOLIS, MN, 55402-0903, US

(21) Appl. No.: 11/031,014

(22) Filed: Jan. 7, 2005

Related U.S. Application Data
(63) Continuation-in-part of application No. 10/339,089, filed on Jan. 9, 2003.
(60) Provisional application No. 60/534,907, filed on Jan. 8, 2004.

(51) Int. Cl. A01D 11/00

(52) U.S. Cl. 294/50.8

(57) ABSTRACT

A debris removal tool having a pair of opposing pivoting blades each having a shape providing light weight and inexpensive manufacture. The blade is a continuous, smooth curve from a straight lower edge to an arcuate, generally semi-circular, upper edge. The outer corners of the upper edges of opposing, complementary blades are pivotally connected to define a pivot axis therebetween. When the blades close, their straight sides and straight lower edge mate, to form a closed bottom, somewhat upright cone shape with a straight bottom edge fully enclosing the debris. The lower edge of each blade is parallel to the pivot axis and may include serrations to enhance grasping of debris. Reinforcing gussets and handle retaining bosses may be provided in the blade to retain the handles and maintain tool rigidity while remaining light in weight.

### CROSS REFERENCE TO RELATED APPLICATIONS

This application is a continuation-in-part of U.S. patent application Ser. No. 10/339,089 filed Jan. 9, 2003, entitled Leaves and Yard Debris Removal Tool, and claims the benefit of priority of U.S. provisional application Ser. No. 60/534,907, filed Jan. 8, 2004, the disclosures of which are hereby incorporated by reference in their entirety.

### FIELD OF THE INVENTION

The present invention relates to the field of tools for grasping and moving loose material and specifically to such tools intended for moving leaves or other lawn and garden debris.

### BACKGROUND OF THE INVENTION

Tools for gathering and removing leaves and other loose debris are well known in the art. Many designs exist, but the tool has yet to be perfected. Part of the reason for this is that the conflicting requirements placed on such a tool push the designer to compromise. The ideal tool would have large capacity, high strength, and light weight; be efficient in picking up the debris; and be easy to use. It would also serve well as a tamping tool.

Large capacity and high strength have been achieved in combination by using a cylindrical shape for the tool. Where the cylinder is split lengthwise and then configured vertically as the two halves of the tool, the cylinder lends its strength to resist the forces applied when the tool is operated. One example of such an approach is disclosed in U.S. Pat. No. 68,903 to Roberts. While intended specifically for removing dirt from post holes, it well illustrates the advantages of a cylindrical blade shape. This patent also illustrates one of the drawbacks to this approach: the lower edges of the blades do not naturally meet. This greatly reduces the tool's effectiveness, especially with fine, loose debris. Altering the shape of the blades to make the edges meet typically results in reduced capacity or edges which curve inward, causing them to trap debris rather than releasing it cleanly. The region at which the edges meet is often substantially smaller that the width of the blades, reducing their 23 effectiveness.

Using a cylinder which has been split and laid on it side helps address the above problem with the lower edges. One example of this is disclosed in U.S. Pat. No. 3,809,421 to James. That patent discloses a tool having straight, aligned edges well suited to scraping the surface and picking up fine debris. The use of a cylinder offers good capacity, but strength and rigidity is compromised. Semi-cylindrical shapes, supported only at their midpoint are known for a tendency to flex. Without additional bracing, the ends of the cylinder are free to twist in opposite directions. As a result, the width of the blades must be restricted to limit this deflection, or bracing must be added. A high range of motion is also needed to take advantage of the available capacity. This is because the edges must open to a distance at least as great as the internal diameter of the space enclosed by the blades in order to fill that space.

Where the debris removal tool is used with leaves or other low density debris, the debris is often placed into trash bags or other containers and then compressed, or tamped, to reduce their volume. This is often done by the user pressing on the debris with a foot or hand, because the tool is unsuitable for this purpose. The straight, downward force needed to tamp the debris is significantly different than the inward force required to grasp the debris. A tool which is optimized for grasping often lacks the structural strength to then tamp that same debris. The most common problem encountered is that the blades flex and may even break.

Many other designs have been used, but one or more of the desired criteria is always compromised. There is a need for a light, easily handled debris removal tool with high capacity and good rigidity. It should have straight, mating lower edge which allow it to grasp fine debris, but the edges should not curve inward substantially, trapping the debris. Ideally the tool would use a blade shape which is self supporting and has sufficient strength and rigidity to handle both the grasping forces and tamping forces encountered in normal use without the addition of substantial bracing. Of course, it would also be preferable if the tool could be manufactured from a relatively small number of parts to reduce manufacturing cost.

The present invention provides a solution to this and other problems, and offers other advantages over the prior art.

### SUMMARY OF THE INVENTION

Against this backdrop the present invention has been developed. The present invention is directed to an apparatus for the removal of leaves or other debris which utilizes a blade design which seeks to optimize strength and capacity without incurring increased weight. This is achieved through the use of a continuously curved blade design having a concave upper edge and a straight lower edge. The upper, curved, portion of the blade maximizes the volume, while the straight lower edge optimizes the ability to grasp small, fine debris. The continuous curved shape provides a strong, self supporting blade which needs minimal bracing.

These and various other features as well as advantages which characterize the present invention will be apparent from a reading of the following detailed description and a review of the associated drawings. According to the invention there is provided a pair of opposing, complementary blades, curved at the top, straight at the bottom, and pivotally connected at the outer corners of the top edges. An optional handle connects to each blade and extends upward beyond the blade to a convenient height for the user.

According to an aspect of the invention the blades incorporate a straight spine extending from the upper to lower edges suitable for attachment of a straight handle and adapted to resist the vertical forces encountered when the tool is used for tamping.

According to another aspect of the invention optional reinforcement may be applied to either or both of the upper and lower edges of the blades. This may be achieved by the addition of an external brace or by rolling or folding the edges themselves. If desired, a wire or other element may be rolled into the edge for further strengthening.

Further in accordance with the invention, the side edges of the blades are formed in a straight line from a point near where the upper edges are interconnected to the outer corners of the lower edges. In this way, the sides of the blades, as well as the lower edges, meet when the blades are closed. This helps retain even fine debris within the cavity of the blades.

Still further in accordance with the invention, the lower edge is preferably as wide, or wider than the body of the tool, this improves the ability of the tool to sweep a surface clean of debris and then grasp that debris across the full width of the tool.

The advantages of such an apparatus are a lightweight, strong debris removal tool that can be manufactured from a minimal number of parts and at a low cost. The blade design is self supporting, capable of resisting both grasping and tamping forces encountered in use, and which lends itself to both injection molding and thermal forming from sheet materials.

### BRIEF DESCRIPTION OF THE DRAWINGS

FIG. 1 is a perspective view of a first embodiment of a debris removal tool according to the present invention, with the tool in the open position.

FIG. 2 is a perspective view of the tool of FIG. 1 in the closed position.

FIG. 3 illustrates the first embodiment exploded into its two matching subassemblies.

FIG. 4 is an exploded view of one of the subassemblies showing its component parts.

FIG. 5 is a perspective view of a first embodiment of the blade used in the tool.

FIG. 6 is a top view of the first embodiment of the blade.

FIG. 7 is a side view of the first embodiment of the blade.

FIG. 8 is a back view of the first embodiment of the blade.

FIG. 9 illustrates a variation on the first embodiment of the debris removal tool having different handle grips.

FIG. 10 is a perspective view of a second embodiment of the blade used in the tool.

FIG. 11 is a detailed view of the upper edge of the second embodiment of the blade.

FIG. 12 is a detailed view of the lower edge of the second embodiment of the blade.

FIG. 13 is a perspective view of another embodiment of the tool in an open position.

FIG. 14 is a perspective view of the embodiment of the tool shown in FIG. 13 in a closed position.

FIG. 15 is a separate side view of one of the blades in the embodiment shown in FIGS. 13 and 14.

FIG. 16 is an upright view the blade shown in FIG. 15 showing the interior surface structure.

### DETAILED DESCRIPTION OF THE INVENTION

The following discussion focuses on several embodiments of the invention, which are intended for use in picking up and bagging leaves. However, as will be recognized by those skilled in the art, the disclosed method and apparatus are applicable to a wide variety of situations in which it is desired to pick up any manner of loose debris or other items.

Glossary

The following is a brief glossary of terms used herein. The supplied definitions are applicable throughout this specification and the claims unless the term is clearly used in another manner.

Blade—that continuously curved portion of the tool which grasps and holds the debris.

Rolling—herein, the method of forming a reinforcement on the upper or lower edge of the blade. The material is rolled in a smooth curve either inward or outward, preferably after heating the material of the blade. The use of the term is intended to also encompass folding the edge of the material.

### Embodiments

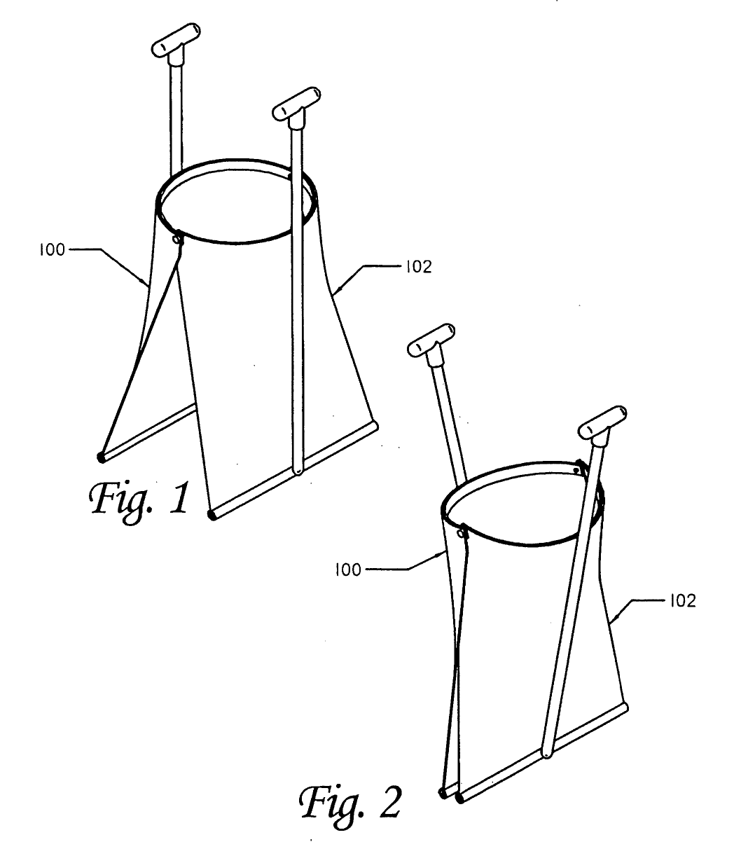

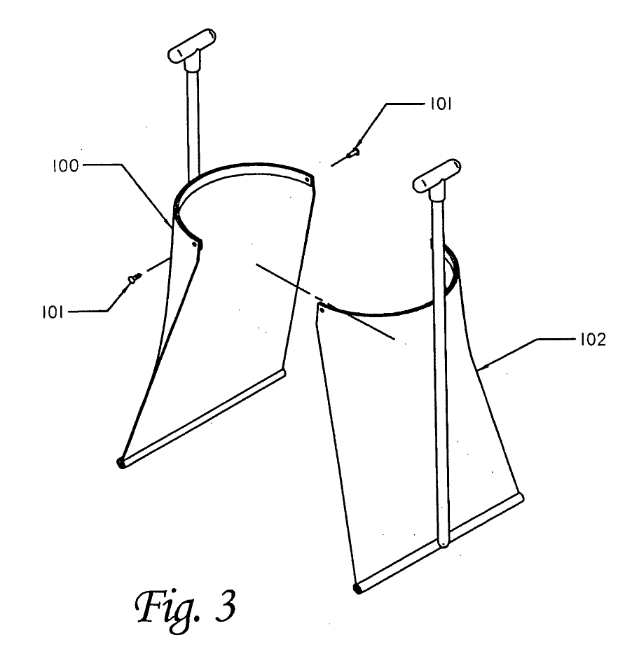

One embodiment of a debris removal tool according the to present invention is illustrated in FIGS. 1-3. As shown, it comprises two opposing substantially identical halves, 100 & 102, pivotally connected by pins or bolts, 101, so that they can open and close. The novelty of the invention is primarily in the configuration and construction of the blade element of the scoop. Its shape allows it to form the majority of the structure of the tool with the addition of only a few parts necessary to complete the tool. The upper corners of the opposing blades are pivotally connected so that as the handles are moved outward, the lower edges of the blades move together.

Each half of the tool preferably comprises the same identical set of elements. For simplicity the structure of only one half will be described, with the understanding that the discussion applies equally to the other half.

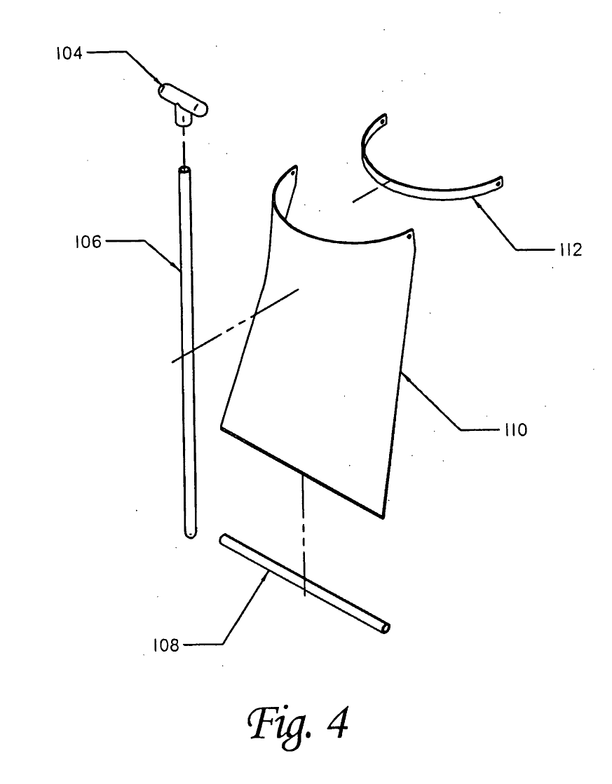

Referring to FIG. 4 the elements of a first embodiment of the tool can be seen. Central to the tool is the blade, 110, and its design which will be discussed more fully below.

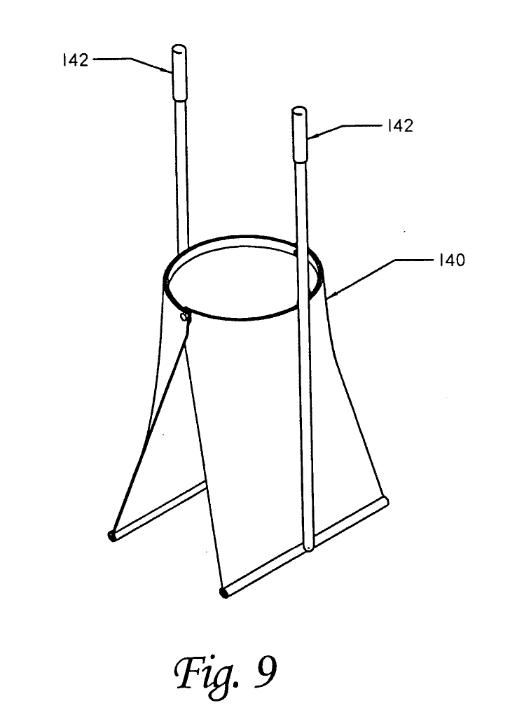

Handle, 106, attaches to the blade, preferably on the outer surface thereof, and extends upward beyond the top edge of the blade. In the illustrated embodiment, T-shaped grips, 104, are used with relatively short handles to optimize gripping from above the tool. The alternative embodiment of FIG. 9 illustrates longer handles with coaxial grips intended to be gripped from the side.

Edge piece, 108, is attached to the lower edge of the blade stiffening that edge and providing an attachment point for the end of the handle, 106. In this manner, some of the inward force of the handle is transmitted directly to the lower edge for improved grasping of the debris and for packing debris into bags or other containers. As discussed below, this piece may also be formed by rolling the edge of the blade.

Brace, 112, attaches to the upper edge of the blade and interconnects the uppermost handle attachment point to the point at the corners of the blade where the two halves of the tool are pivotally coupled. As with edge piece, 108, the upper edge brace may be formed by rolling the edge.

The handle, 106, edge piece, 108, and brace, 112, may be joined to the blade in any appropriate manner and the selection of method will likely depend upon the specific materials used. In the preferred embodiment attachment is by means of bolts penetrating through the blade and part and retained by a nut. Screws, straps, and adhesive or chemical bonding are clearly among the applicable alternative methods of attachment. Where a separate reinforcing member is attached to the lower edge, the handle may mechanically interlock with the reinforcing member or may be formed integrally therewith.

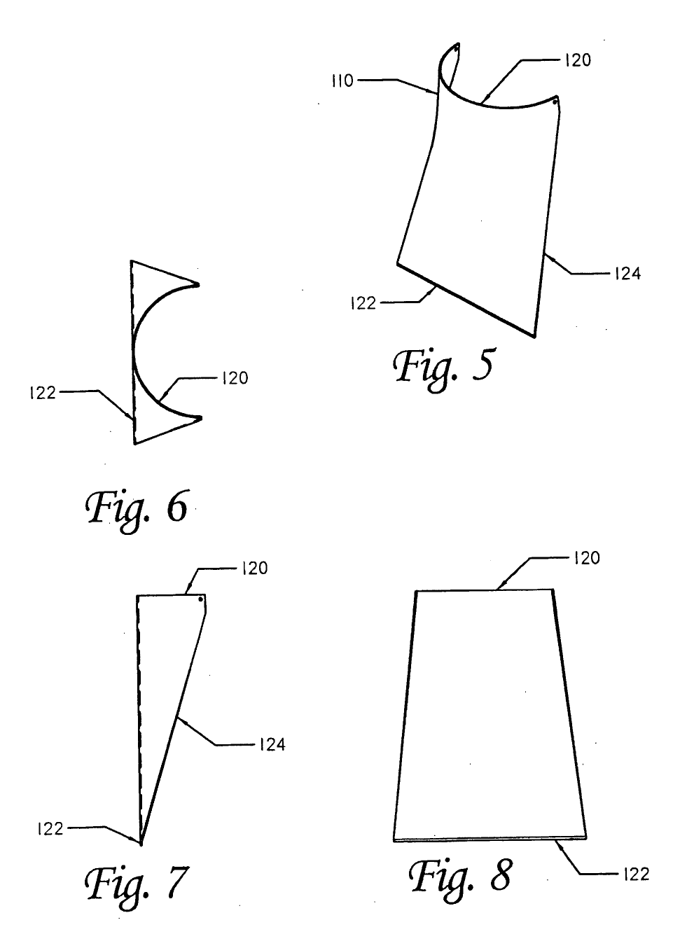

The design of the blade, 110, is illustrated in detail in FIGS. 5-8. The top edge, 120, is preferably formed as a semi-circle, open to the top, with the concave portion oriented toward the opposing blade when assembled into a tool. The semi-circular, concave shape balances the needs for strength and enclosed volume while also providing for ease of manufacture. In use, the handles will be applying outward force at the top edge of the blades which the curved shape handles with minimal distortion and no high stress points. The open top design allows large, overflowing loads to be picked up without interference.

The lower edge, 122, is formed as a straight edge, substantially perpendicular to the vertical centerline of the blade. Other angles are clearly applicable. The straight edge allows the blade to effectively “sweep” a wide expanse of the surface upon which the debris rests for efficient debris removal. The straight edge is also effective for tamping the debris into bags or other containers. In the preferred embodiment, the lower edge is at least as wide as the remainder of the blade, preferably somewhat wider. This further increases the efficiency of the tool by increasing the area which can be swept of debris.

The side edges, 124, of the blade viewed from the side, as in FIG. 7, taper from near the top to the lower edge. This allows the lower edges of opposing blades to closely meet when the tool is closed, enabling the tool to grasp relatively fine debris, and the side edges to meet to retain the debris.

The strength of the blade is achieved by the smooth, continuously curved transition of the body of the blade from the semi-circular top edge to the straight lower edge. The result is a blade which is at least partially curved for the majority of its length but which comes to a straight, pointed edge. This maximizes the ability of the blade to resist the outward forces applied by the debris while providing a large, straight edge for effective grasping and pick up. The configuration also offers a straight portion down the middle of the blade. This “spine” enhances the stiffness needed for tamping and provides an area to which the handle is easily fastened. This allows the handle to be a simple, straight piece for easier and cheaper manufacture. All of these features are achieved in a blade which can be easily manufactured as a single piece using a variety of methods. While the blade can clearly be injection molded, it can also be formed from sheet material. This enables its low cost manufacture from plastics, metals, or any other formable sheet goods.

One advantage of this embodiment of the present invention is that it allows the tool to be manufactured from a variety of materials while retaining its strength and light weight. This embodiment utilizes thermal formed plastic sheet for the blade, PVC pipe for the handles and edge piece, and an aluminum strip for the upper edge brace. Injection molding is clearly an option for the blade as is stamping from aluminum or other metal. Wood or aluminum tubing are good options for the handles. The lower edge piece and upper edge brace could be plastic, aluminum, steel, or a variety of other materials. Their shape could also be varied to achieve desired strength. T or L shaped profiles are clearly applicable among others.

The following discussion presents alternative embodiments which offer various advantages in structure or functions without departing from the principles of the invention.

FIG. 9 illustrates a slight variation, 140, on the first embodiment of the present invention in which the type and orientation of the handle grips, 142, to optimize them for gripping from the side rather than from the top.

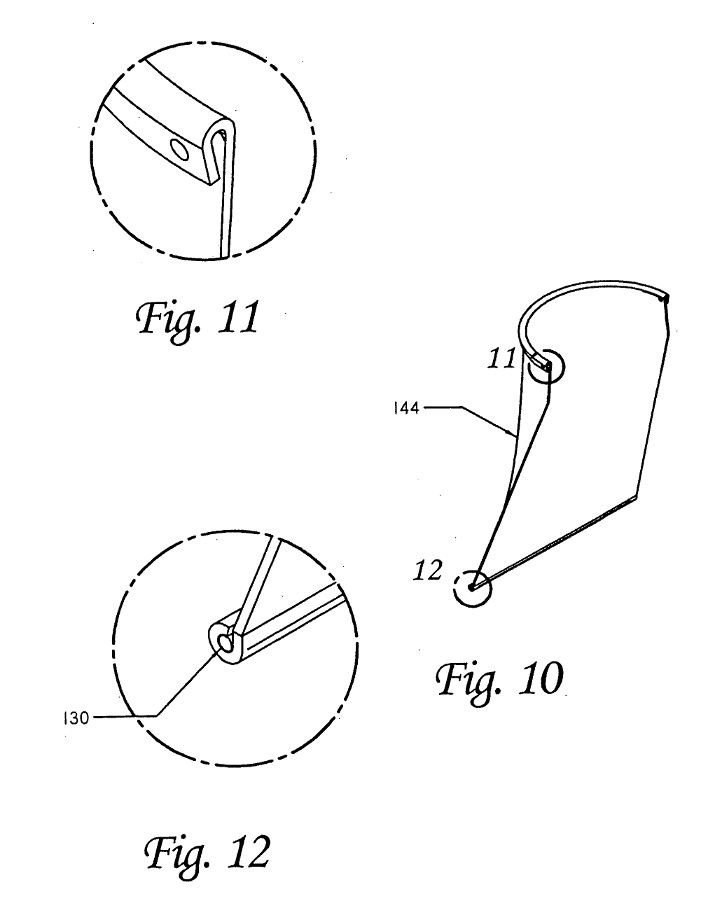

FIGS. 10-12 illustrate a second embodiment, 144, of the blade in which the reinforcement of the upper and lower edges are formed integrally by rolling or folding the edges of the blade. Differing levels of strength can be achieved by varying the size of the roll and the number of layers. Additional strength or different flexibility characteristics can be achieved by embedding wire, 130, or other material as a strengthening member within the rolled edge.

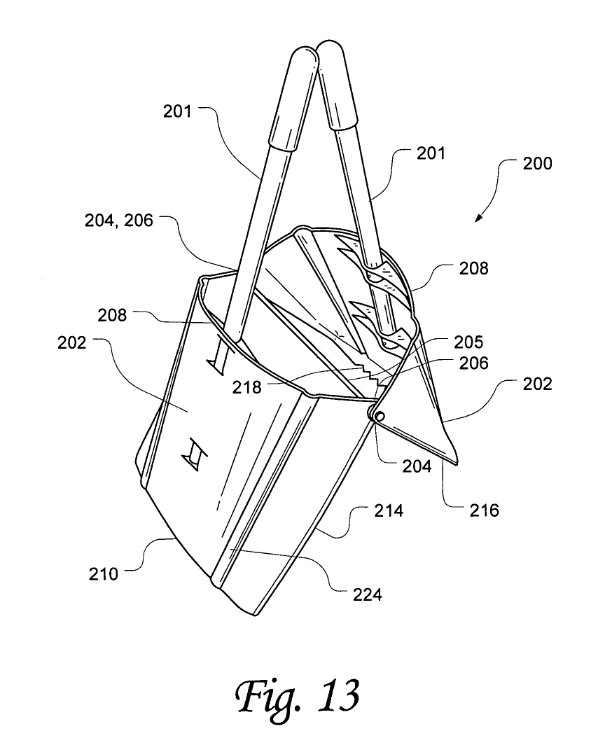

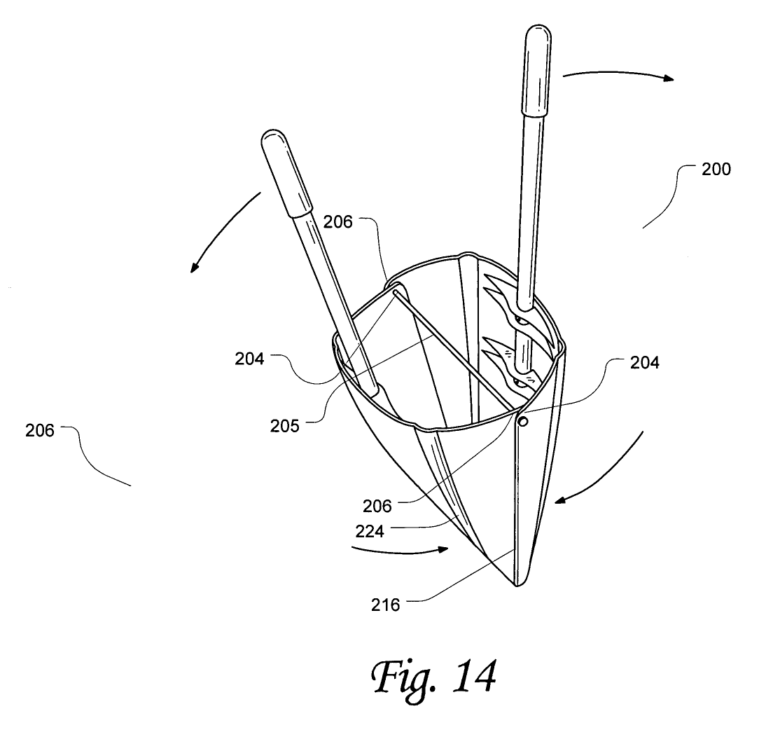

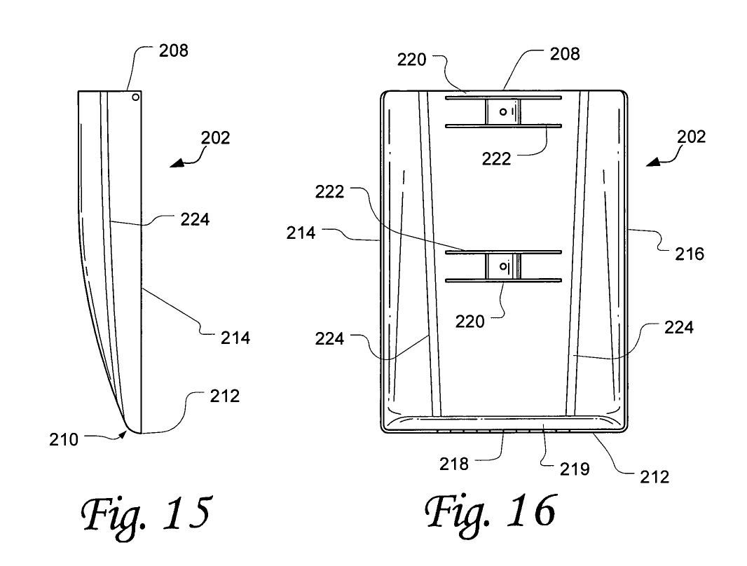

Another embodiment is shown in FIGS. 13, 14, 15 and 16. Referring first to FIG. 13, the debris removal tool 200 is shown in a perspective view in an open position. FIG. 14 shows the tool 200 in a closed position. This clamshell tool 200 has a pair of straight rod handles 201 that attach to two opposing blade members 202. The blade members 202 are fastened together at upper corners 204 and 206 so that the blade members 202 pivot between an open position with the handles 201 close together and a closed position with the handles 201 spread apart. The blade members rotate about a pivot line defined by and through a rod 205 between the opposing joined upper corners 204 and 206.

The two blades 202 are identical in shape and are preferably made of an injection molded plastic. Each blade 202 is concave sheet shaped member having an upper substantially curved edge 208 lying in a first plane. Each blade 202 extends generally straight to a bottom end portion 210. The bottom end portion 210 has a curved cross sectional shape, terminating in a bottom edge 212 that extends generally parallel to the pivot line and rod 205 between the upper corners 204 and 206. Each blade 202 has an outer, generally flat surface shape between the upper edge 208 and the bottom end portion 210 that gradually straightens from the curved upper edge 208 to the straight bottom end portion 210. Each side edge 214 and 216 of the blade 202 is straight and extends at a right angle from the corner 204 and 206 respectively to the bottom edge 212. The side edges 214 and 216 and the bottom edge 212 together lie in a single second plane that is preferably normal to the first plane.

The bottom end portion 210 curves into the straight bottom edge 212 such that when the two blades are closed together, the mating side edges 204 and 206 and bottom edges 212 mate together to contain leaves or other yard debris within the tool 200. Preferably edges 212 each has a number of serrations 218 or teeth formed along the edge 212 to aid in grasping and holding lawn debris. Bottom end portion 210 also preferably curves toward the straight bottom edge 212 such that there is a straight, flat surface portion 219 adjacent the edge 212.

Each blade 202 has a pair of vertically aligned bosses 220 formed midway along its inner surface that receive one of the handles 201 therethrough. Each boss 220 also has two pairs of radially extending support gussets 222 each extending outward therefrom toward one of the side edges 214 or 216.

Each blade 202 further may be provided with a pair of narrowly curved straight ribs 224 extending alongside the bosses 220 between the upper edge 208 and the bottom end portion 210. These ribs 224 provide a measure of rigidity to the clamshell structure of the tool 200 during operation. Each blade 202 is preferably injection molded into final shape as a single body. Rod 205 is fitted with press washers at each end to fasten the two blades together at the corners 204 and 206. The rod 205 is preferably made of aluminum and the press washers have steel tabs that dig into the aluminum to retain them in place on the rod and in turn fasten the corners 204 and 206 to the rod 205. The handles 201 are preferably made of tubular plastic but may also be made of wood, metal or other suitable material. Although blades 202 are preferably made of injection molded plastic, other materials may alternatively be used such as aluminum or other light weight sheet metal material.

While not illustrated herein, the invention could clearly be practiced without the illustrated handles. The user could directly grip the outside of the blades, squeezing them together to capture the debris. Preferably the blades would be fitted with loops, grips, or other gripping means affixed to the outer surface of the blades to assist the user. While the preferred form of the invention has been disclosed above, alternative methods of practicing the invention will be readily apparent to the skilled practitioner. The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A yard debris and leaf removal tool comprising:
a pair of opposing curved blade members each having an outwardly curved body with a pair of spaced opposing upper corners, wherein the facing pairs of upper corners of the blade members are joined together so as to pivot about a pivot axis through the joined corners, each blade member having an outwardly curved edge extending between the spaced upper corners and a straight linear side edge extending from one of the upper corners to one end of a generally straight bottom edge of the blade member, wherein the bottom edge of the blade member substantially extends along a line parallel to the pivot axis; and
a pair of handles each fastened to one of the blade members so that the handles may be moved toward each other about the pivot axis of the blade members to place the tool in an open position and away from each other to close the blades together to a closed position.

2. The tool according to claim 1 wherein the curved blade member extends in a straight direction from the upper outwardly curved edge extending between the upper corners to a bottom end portion terminating at the straight bottom edge.

3. The tool according to claim 1 wherein the bottom edge of the blade member has a series of serrations along a portion of its length for grasping debris.

4. The tool according to claim 1 further comprising:
a pair of bosses formed in each blade member for receiving one of the rod shaped handles; and
a pair of radial ribs extending from each of the bosses.

5. The tool according to claim 4 wherein the bosses protrude from an inner surface of the blade members.

6. The tool according to claim 1 wherein the side edges and the bottom edge lie of each blade member in a single plane and the upper curved edge lies in a plane normal to the single plane.

7. The tool according to claim 2 wherein the straight direction is orthogonal to the bottom edge.

8. A yard debris and leaf removal tool comprising:
a pair of opposing curved blade members each having an outwardly curved body with a pair of spaced opposing upper corners, wherein the facing pairs of upper corners of the blade members are joined together so as to pivot about a pivot axis through the joined corners, each blade member having an outwardly curved edge extending between the spaced upper corners and a straight linear side edge extending from one of the upper corners to one end of a generally straight bottom edge of the blade member, wherein the bottom edge of the blade member substantially extends along a line parallel to the pivot axis and has a series of serrations extending along a portion of its length; and
a pair of handles each fastened to one of the blade members so that the handles may be moved toward each other about the pivot axis of the blade members to place the tool in an open position and away from each other to close the blades together to a closed position.

9. The tool according to claim 8 wherein the curved blade member extends in a straight direction from the upper outwardly curved edge extending between the upper corners to a bottom end portion terminating at the straight bottom edge.

10. The tool according to claim 8 wherein the side edges and the bottom edge lie of each blade member in a single plane and the upper curved edge lies in a plane normal to the single plane.
